(19) United States
(12) Patent Application Publication
(10) Pub. No.: US 2016/0234160 A1
(43) Pub. Date: Aug. 11, 2016

(54) LOCATION-BASED ADDRESS BOOK TAILORED FOR USE DURING UPCOMING TRAVEL

(71) Applicant: Microsoft Technolgy Licensing, LLC, Redmond, WA (US)

(72) Inventor: Dhirendra Bhupati, Redmond, WA (US)

(21) Appl. No.: 14/618,527

(22) Filed: Feb. 10, 2015

(51) Int. Cl. H04L 29/12; H04W 4/02; H04W 4/16

(52) U.S. Cl. CPC H04L 61/1594; H04W 4/16; H04W 4/021

(57) ABSTRACT

A method for dynamically generating a location-based contact list available on a local device of a user is provided. In accordance with the method, contextual data concerning user contacts is collected. The contextual data describes the behavior of the user contacts and provides indicia of geographic locations where the user contacts will be present at future times. Based on the collected contextual data, selected ones of the user contacts are identified who will be present at a specified geographic location at a specified future time. A location-based contact list is populated with the selected ones of the user contacts who will be present at the specified geographic location at the specified future time. The specified geographic location may be a location the user will be visiting at the specified future time.

### BACKGROUND

Many personal electronic devices (such as mobile phones and the like) include a contact list function such as an address book which displays selected personal data from a database concerning individuals and/or businesses and other such entities. Contact data may include a name, mailing address, phone number(s), e-mail address, company, job title, and sometimes an image for each entry. Address books may be stored locally in a user's electronic device or online. Online address books may invite people to register and then upload contact information for people belonging to their personal and business network.

A contact entry in an address book may be assigned to one or more groups of contacts. For example, certain contacts may be assigned to a group designated “local contacts,” who are contacts who work and/or reside in the same geographic region as the user. Additionally, location-based services are available which can tell a user if any of his or her contacts are currently nearby.

This background is provided to introduce a brief context for the summary and detailed description that follow. This background is not intended to be an aid in determining the scope of the claimed subject matter nor be viewed as limiting the claimed subject matter to implementations that solve any or all of the disadvantages or problems presented above.

### SUMMARY

A location-based address book component operating on a mobile computing device such as a smartphone, tablet, or laptop personal computer (pc) is configured to enable a user to generate a group of the user's contacts who may be traveling to the same location as the user at some time in future. Not only does this eliminate the need for the user to search through numerous contacts to locate contacts the user knows in advance will visiting the specified location, it can also identify contacts whom the user did not know would visiting that location at the same time as the user.

In various illustrative examples, the location-based address book component, alone or in coordination with one or more other components such as a personal digital assistant component, can collect contextual data concerning the online activities of the user's contacts to infer or otherwise determine if one or more of the user contacts may be visiting the same geographic location as the user at some common time in the future. The location-based address book component may then populate a location-based contact list with those user contacts so that they are easily accessible to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It may be appreciated that the above-described subject matter may be implemented as a computer-controlled apparatus, a computer process, a computing system, or as an article of manufacture such as one or more computer-readable storage media. These and various other features may be apparent from a reading of the following Detailed Description and a review of the associated drawings.

### DESCRIPTION OF THE DRAWINGS

FIG. 1 shows an illustrative environment in which devices having communications capabilities interact over a network;

FIG. 2 shows illustrative communications between devices;

FIG. 3 shows an illustrative layered architecture that includes an application layer, operating system (OS) layer, and hardware layer;

FIGS. 4, 5 and 6 show illustrative interfaces between a user and a location-based address book component;

FIG. 7 shows illustrative inputs to the location-based address book component and an illustrative taxonomy of features and functions that may be supported by the location-based address book component;

FIG. 8 shows an illustrative arrangement in which the location-based address book component interacts with a digital assistant that may be instantiated on a device;

FIG. 9 is a conceptual diagram illustrating the generation of a location based address book;

FIGS. 10-11 show screen captures of illustrative user interfaces (UIs) displayed on a device at various points in a location sharing session during and after a phone call;

FIG. 12 shows an illustrative method that may be performed when implementing the present location-based address book;

FIG. 13 is a simplified block diagram of an illustrative computer system;

FIG. 14 is a simplified block diagram of an illustrative architecture for a device capable of executing the various components described herein for providing location-based contact lists; and

FIG. 15 shows a block diagram of an illustrative device that may be used in part to implement the present location-based address book.

Like reference numerals indicate like elements in the drawings. Elements are not drawn to scale unless otherwise indicated. It is emphasized that the particular UIs displayed in the drawings can vary from what is shown according to the needs of a particular implementation. While UIs are shown in portrait mode in the drawings, the present arrangement may also be implemented using a landscape mode.

### DETAILED DESCRIPTION

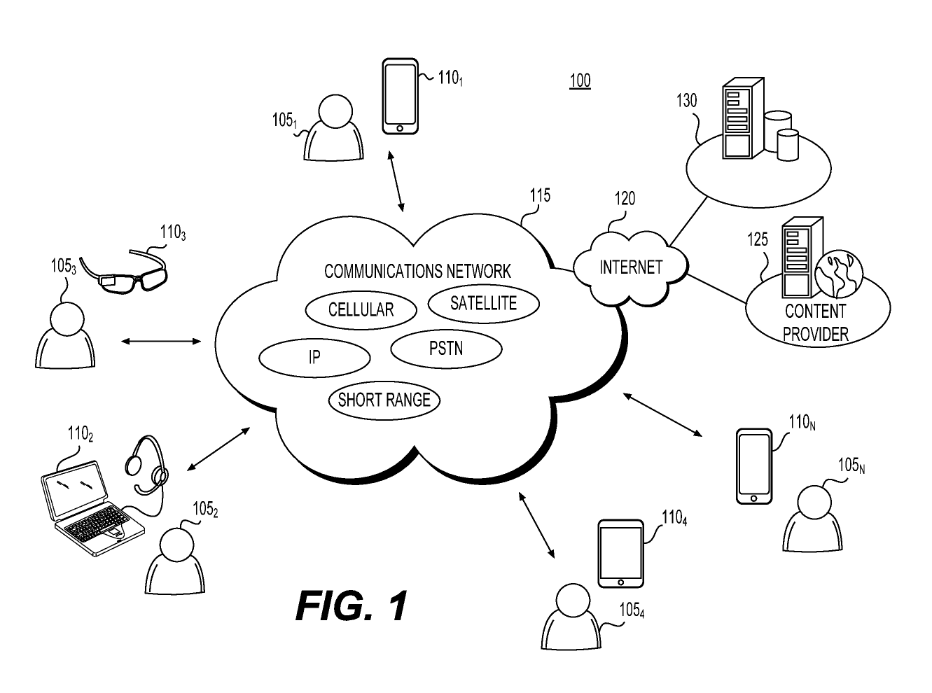

FIG. 1 shows an illustrative communications environment 100 in which various users 105 employ respective devices 110 that communicate over a communications network 115. The devices 110 provide various communication capabilities, such as voice and video calling and messaging, and typically support data-consuming applications such as Internet browsing and multimedia (e.g., music, video, etc.) consumption in addition to various other features. The devices 110 may include, for example, user equipment, mobile phones, cell phones, feature phones, tablet computers, and smartphones which users often employ to make and receive voice and/or multimedia (i.e., video) calls, engage in messaging (e.g., texting), use applications and access services that employ data, browse the World Wide Web, and the like. However, alternative types of electronic devices are also envisioned to be usable within the communications environment 100 so long as they are configured with communication capabilities and can connect to the communications network 115. Such alternative devices variously include handheld computing devices, PDAs (personal digital assistants), portable media players, phablet devices (i.e., combination smartphone/tablet devices), wearable computing devices (e.g., glasses, watches, etc.), navigation devices such as GPS (Global Positioning System) systems, laptop PCs (personal computers), or the like. In the discussion that follows, the use of the term “device” is intended to cover all devices that are configured with communication capabilities and are capable of connectivity to the communications network 115.

The various devices 110 in the environment 100 can support different features, functionalities, and capabilities (here referred to generally as “features”). Some of the features supported on a given device can be similar to those supported on others, while other features may be unique to a given device. The degree of overlap and/or distinctiveness among features supported on the various devices 110 can vary by implementation. For example, some devices 110 can support touch controls, gesture recognition, and voice commands, while others may enable a more limited UI. Some devices may support video consumption and Internet browsing, while other devices may support more limited media handling and network interface features.

As shown, the devices 110 can access the communications network 115 in order to implement various user experiences. The communications network can include any of a variety of network types and network infrastructure in various combinations or sub-combinations including cellular networks, satellite networks, IP (Internet Protocol) networks such as Wi-Fi and Ethernet networks, a public switched telephone network (PSTN), and/or short range networks such as Bluetooth networks. The network infrastructure can be supported, for example, by mobile operators, enterprises, Internet service providers (ISPs), telephone service providers, data service providers, and the like. The communications network 115 typically includes interfaces that support a connection to the Internet 120 so that the mobile devices 110 can access content provided by one or more content providers 125 and access a service provider 130 in some cases.

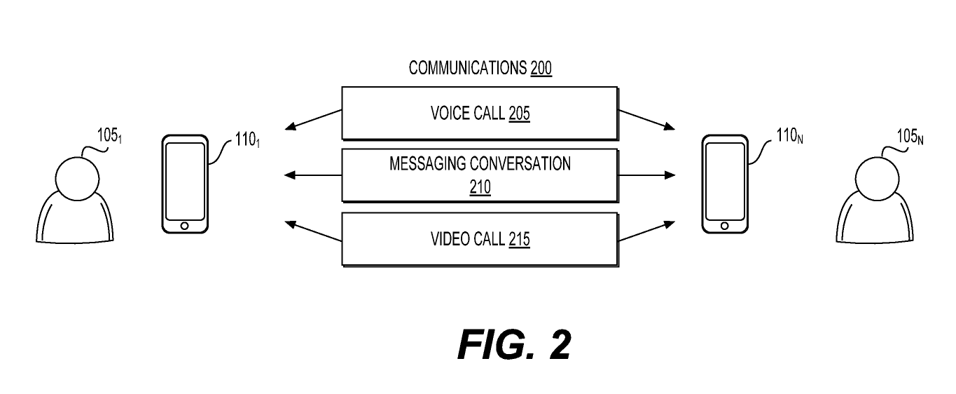

The devices 110 and communications network 115 may be configured to enable device-to-device communication. As shown in FIG. 2, such device-to-device communications 200 can include, for example, voice calls 205, messaging conversations 210, and video calls 215. Support for device-to-device communications 200 may be provided using various applications that run on a device 110.

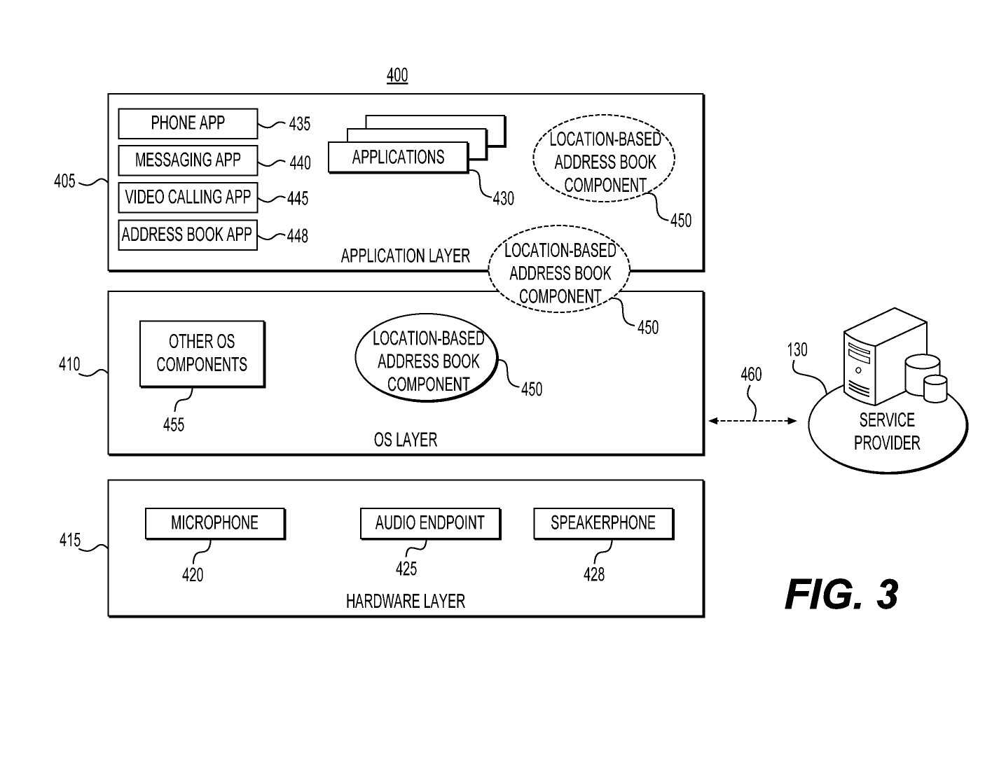

The present location-based address book may be implemented using components that are instantiated on a given device. In addition, the location-based address book functionality can also be implemented, in whole or part, using a web service supported by a remote service provider (e.g., service provider 130 in FIG. 1). FIG. 3 shows an illustrative layered architecture 400 that supports communication applications and other components. The architecture 400 is typically implemented in software, although combinations of software, firmware, and/or hardware may also be utilized in some cases. The architecture 400 is arranged in layers and includes an application layer 405, an OS (operating system) layer 410, and a hardware layer 415. The hardware layer 415 provides an abstraction of the various hardware used by the device 110 (e.g., input and output devices, networking and radio hardware, etc.) to the layers above it. In this illustrative example, the hardware layer supports a microphone 420 and audio endpoint 425 which may include, for example, a wired or wireless headset/earpiece, external speaker/device, and the like, and the device's speakerphone 428.

The application layer 405 in this illustrative example supports various applications (apps) 430 (e.g., web browser, map application, email application, etc.), as well as a phone app 435, messaging app 440, and video calling app 445, such as Skype™ and an address book app 448. The applications are often implemented using locally executing code. However in some cases, these applications may rely on services and/or remote code execution provided by remote servers or other computing platforms such as those supported by the service provider 130 or other cloud-based resources as indicated by line 460. While the apps 430, 435, 440, 445 and 448 are shown here as components that are instantiated in the application layer 405, it may be appreciated that the functionality provided by a given application may be implemented, in whole or part, using components that are supported in either the OS or hardware layers.

The OS layer 410 supports a location-based address book component 450 and various other OS components 455. In some cases, location-based address book component 450 can interact with the service provider. That is, the location-based address book component 450 in some implementations can partially utilize or fully utilize remote code execution supported at the service provider 130, or using other remote resources. In addition, it may utilize and/or interact with the other OS components 455 (and/or other components that are instantiated in the other layers of the architecture 400) as may be needed to implement the various features and functions described herein. The location-based address book component 450 may alternatively be instantiated using elements that are instantiated in both the OS and application layers or be configured as an application, as shown in FIG. 3 using the dashed-line ovals. It may also be appreciated that the functionality provided by the location-based address book component 450 can be implemented, in whole or part, using components that are supported in either the application or hardware layers.

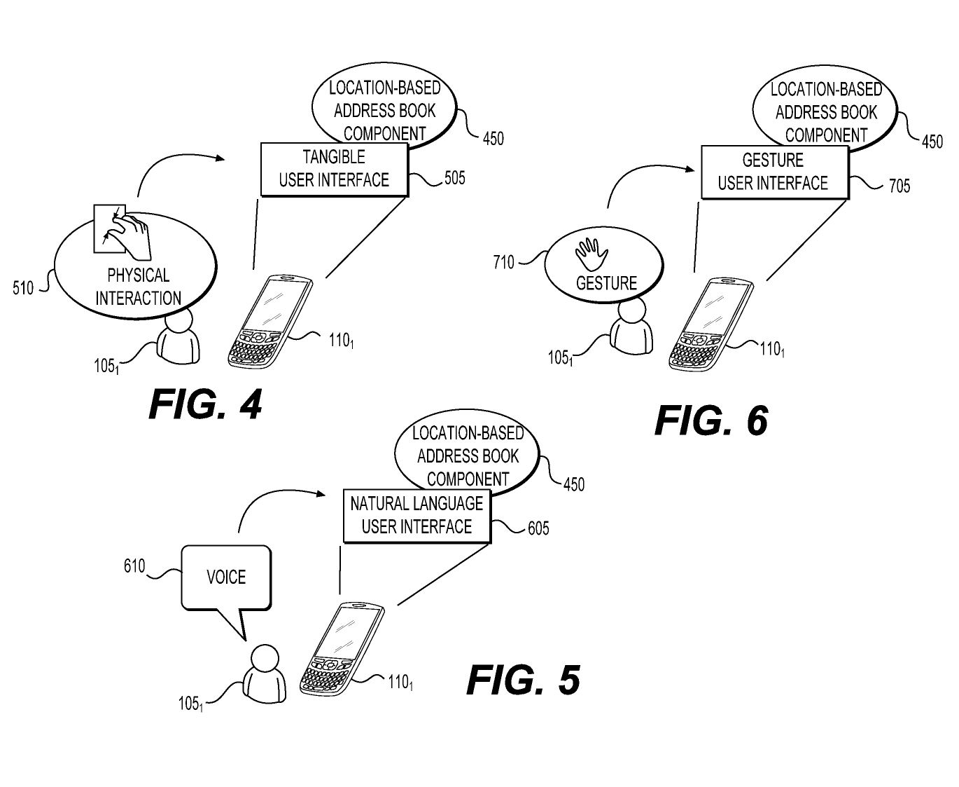

A user can typically interact with the location-based address book component 450 (FIG. 3) in a number of ways depending on the features and functionalities supported by a given device 110. For example, as shown in FIG. 4, the location-based address book component 450 may expose a tangible user interface 505 that enables the user 105 to employ physical interactions 510 in support of the location sharing experiences on the device 110. Such physical interactions can include manipulation of physical and/or virtual controls such as buttons, menus, keyboards, etc., using touch-based inputs like tapping, flicking, dragging, etc. on a touchscreen, and the like. In some implementations, the location-based address book component may expose a natural language user interface 605 shown in FIG. 5, or alternatively a voice command-based user interface (not shown), with which the user employs voice 610 to provide various inputs to the device 110. In other implementations, the location-based address book component 450 may expose a gesture user interface 705 shown in FIG. 6 with which the user 105 employs gestures 710 to provide inputs to the device 110. It is noted that in some cases, combinations of user interfaces may be utilized where the user may employ, for example, both voice and physical inputs to interact with the location-based address book component 450 and the device 110. The user gestures can be sensed using various techniques such as optical sensing, touch sensing, proximity sensing, and the like.

In accordance with one aspect of the disclosure, the location-based address book component 450 generates an ad hoc subset of the user's contacts who are going to be traveling to the same location as the user at some upcoming time in the future. That is, a subset of the user's contact list is dynamically generated and populated with any user contacts who the user might meet with or otherwise contact during an upcoming trip. By way of example, if the user is planning to attend a conference in Los Angeles from April 5-9, it would helpful to know that Mary, who is one of the user's contacts and lives in Maine, will also be in Los Angeles from say, April 3-6, either because she is attending or same conference or for some other totally unrelated reason.

Additional contacts may be added to the location-based contact list generated by the location-based address book component 450 even though they are not part of the user's main contact list. Specifically, certain categories of contacts may be added to the user's location-based contact list and may be dynamically populated with contact records that are relevant to the particular locale that the user will be visiting during the upcoming trip. For example, telephone numbers for taxi companies, public transit, restaurants, and emergency services, may be automatically added to the list, either in advance of the trip or when the user arrives at the location.

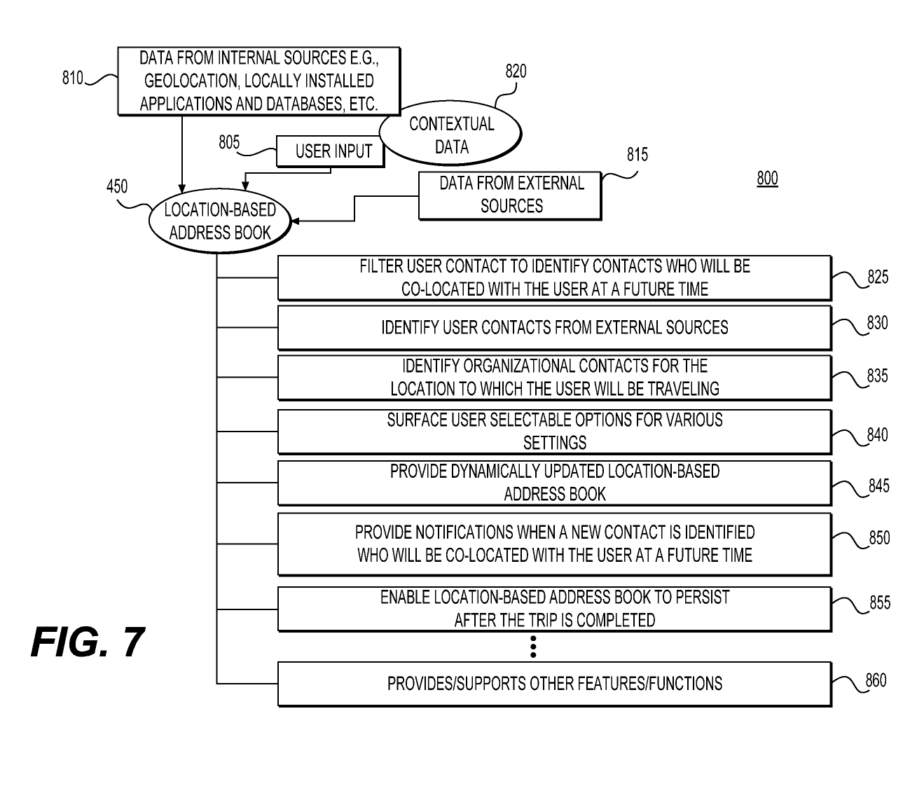

FIG. 7 shows an illustrative taxonomy of functions 800 that may typically be supported by the location-based address book component 450. Inputs to the location-based address book component 450 typically can include user input 805, data from internal sources 810, and data from external sources 815. For example, data from internal sources 810 could include data from locally installed applications and databases and data from various sensors such as the current geolocation of the device 110 that may be reported by a GPS (Global Positioning System) component on the device, or some other location-aware component. The externally sourced data 815 includes data provided, for example, by external systems, databases, services, and the like such as the service provider 130 (FIG. 1). The various inputs can be used alone or in various combinations to enable the location-based address book component 450 to utilize contextual data 820 when it operates.

Contextual data 820 can include, for example, time/date, the user's location, language, schedule, applications installed on the device, the user's preferences, the user's behaviors (in which such behaviors are monitored/tracked with notice to the user and the user's consent), stored contacts (including, in some cases, links to a local user's or remote user's social graph such as those maintained by external social networking services), call history, messaging history, browsing history, device type, device capabilities, communications network type and/or features/functionalities provided therein, data associated with other parties to a communication (e.g., their schedules, preferences, etc.), and the like. Additional illustrative examples of the use of context by the location-based address book component are provided below.

As shown, the functions 800 illustratively include filtering user contacts to identify those contacts who will be co-located with the user at a future time (as indicated by reference numeral 825); identifying user contacts from external sources (830); identifying organizational contacts for the geographic location to which the user will be traveling (835); surfacing user selectable options for various settings (840); providing a dynamically updated location-based address book (845); providing notifications when a new contact has been identified who will be co-located with the user at a future time (850); enabling a location-based address book or contact list to persist after the trip is completed (855) and providing and supporting other features and functionalities (860). The list of functions 800 is not intended to be exhaustive and other functions may be provided by the location-based address book component as may be needed for a particular implementation of the present location sharing. Moreover, not all the enumerated functions may be provided in any given implementation.

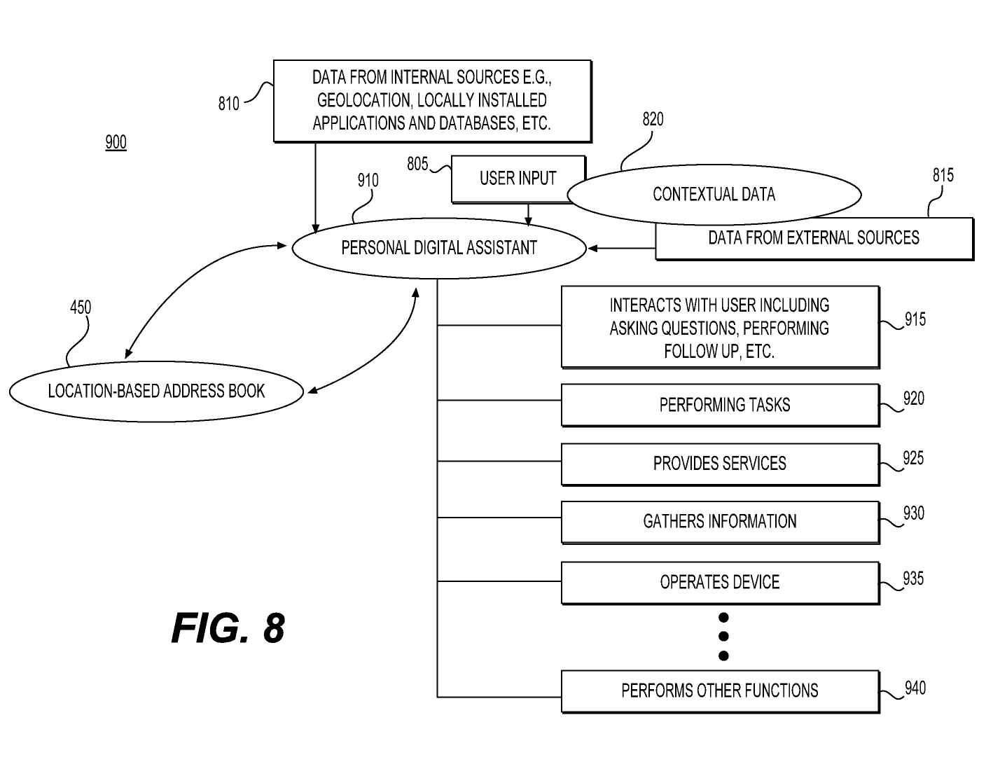

In some implementations, the location-based address book component 450 can be configured to interoperate with a personal digital assistant that is operable on the device 110. As shown in FIG. 8, a personal digital assistant 910 can expose a variety of functions 900 which illustratively include interacting with the user 915 (through the natural language user interface and/or other user interfaces, for example); performing tasks 920 (e.g., making note of appointments in the user's calendar, sending messages and emails, etc.); providing services 925 (e.g., answering questions from the user, mapping directions to a destination, etc.); gathering information 930 (e.g., finding information requested by the user about a book or movie, locating the nearest Italian restaurant, etc.); operating the device 935 (e.g., setting preferences, adjusting screen brightness, turning wireless connections such as Wi-Fi and Bluetooth on and off, etc.); and performing various other functions 940. The list of functions 900 is not intended to be exhaustive and other functions may be provided by the digital assistant as may be needed for a particular implementation of the present location-based address book.

In a similar manner as with the arrangement shown in FIG. 7, inputs to the digital assistant 910 can include user input 805, data from internal sources 810, data from external sources 815, and contextual data 820.

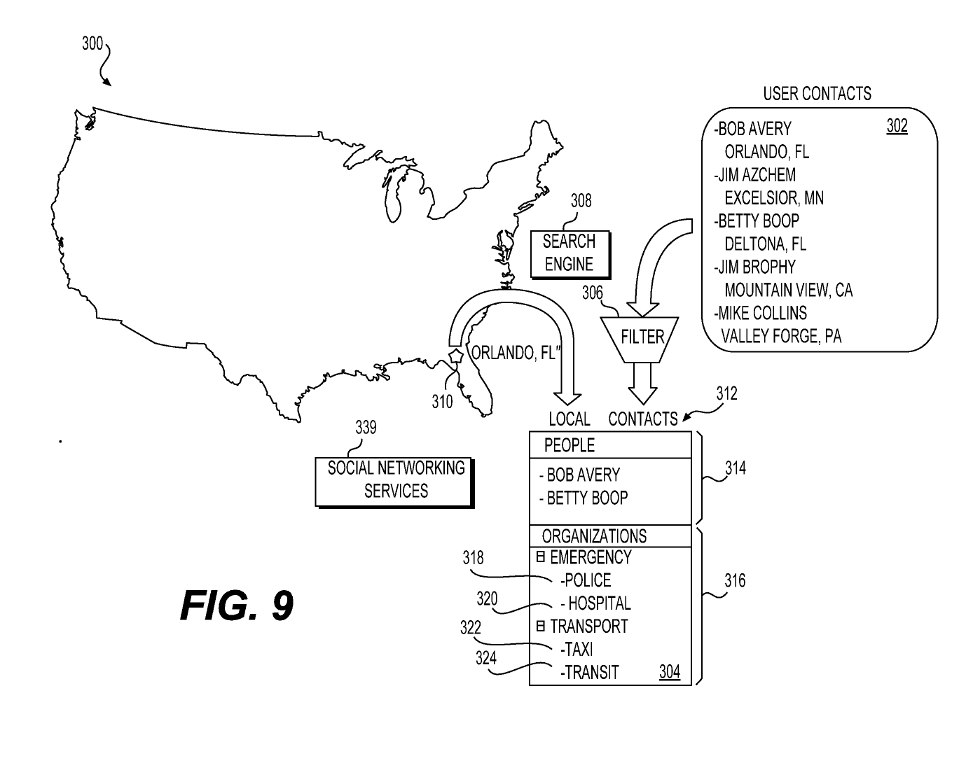

FIG. 9 is a conceptual diagram illustrating the generation of a location based address book. The location based address book 312 includes a list of people 314 that are associated with a geographic location 310 and a list of organizations 316 that are associated with the geographic location 310. The list of people 314 can be filtered 306 from a more complete list of user contacts 302. The more complete list of user contacts includes contacts associated with a variety of different locations. In some implementations, the more complete list of user contacts 302 is user-defined (i.e., each contact in the list has been selected for inclusion in the list by the user). In other implementations the more complete list of user contacts 302 may include contacts who have been obtained from the user's social graph, which may be maintained by one or more external social networking services 339. The address book may be dynamically populated with such contacts without direct user intervention.

The list of organizational contacts 316 is not drawn from the list of user contacts 302, but may be retrieved from a search engine 308 as being associated with both the location 310 and specific categories of services. For example, the search engine 308 provides contacts 318, 320, 322, and 324 that are specific to “Orlando, Fla.” for the “Police,” “Hospital,” “Taxi,” and “Transit” categories of services.

The geographic location 310 may be a geographic location where a user of a device is expected to be during an upcoming specified period of time, possibly for business or leisure travel. In some implementations the list of people 314 that are associated with a geographic location 310 are also people who will be at that same location during at least a portion of that same period of time. The list of people may include people who reside or work at that location, but may also include people who will also be visiting that geographic location 310 for a limited period of time.

The list of people 314 may be obtained in any of a variety of different ways. For example, the location-based address book component 350 residing in whole or in part on the user's device may coordinate with the personal digital assistant component 910 (see FIG. 8) to obtain contextual data 820 (see FIG. 7) about the individuals in the list of user contacts 302. Such contextual data may relate to the behavior (e.g., online activity) of the user contacts from which information can be extracted indicating that the contacts may be traveling to some geographic at a specified time in the future.

The contextual data can be obtained, for example, from any of the various inputs shown in FIG. 7. For instance, external sources of contextual data may include calendars that are maintained by the individuals in the list of user contacts 102. Such calendars may reside on devices associated with those individuals or on an online calendar maintained by a service provider, for example. In the event that the calendars reside on another user's device, the calendars may be accessed, for example, using device-to-device communication (with notice to the other and the other user's consent). Other external sources of contextual data may include social networking services, various web sites and the like.

In the case of social networking services, the list of people 314 who will be at the geographic location 110 during a period of time that overlaps with the period of time during which the user will be at that location may be obtained not only from calendars, but also from other sources such as posts, check-ins, timelines, chats, tweets, tickers, blogs and so on. Of course, the location-based address book component 450 may aggregate data from any of the aforementioned illustrative sources, as well as other sources not mentioned above.

Contextual data also can be obtained from internal sources of data that may be reside on the user's device. Such data may be extracted, for example, from stored text messages, tweets, emails and other data associated with various applications that may reside on the user's device.

As previously mentioned, the contextual data may be used by the location-based address book component examine all the online activity of user contacts to determine if one or more of them will be traveling to specified location at some time in the future. For example, the location based address book component 450 (possibly in coordination with one or more other components such as the personal digital assistant 910) may determine that Mary has been spending time on travel websites searching for information about Los Angeles. This, coupled with additional contextual information gleaned from various sources, including possibly Mary's other online activities, may be used to determine that Mary is in fact planning an upcoming trip to Los Angeles.

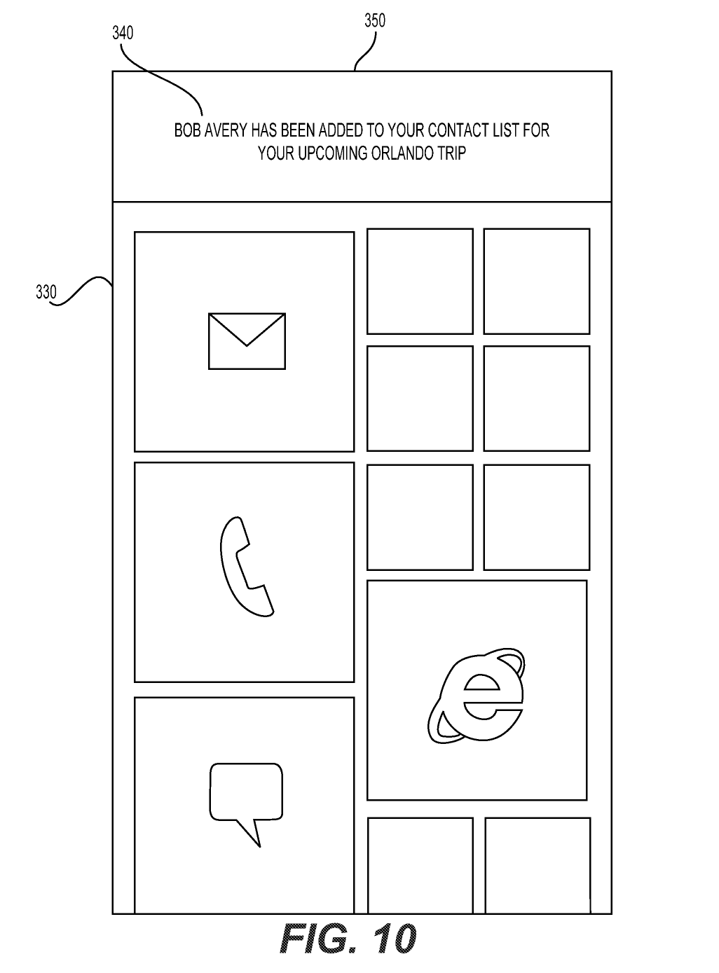

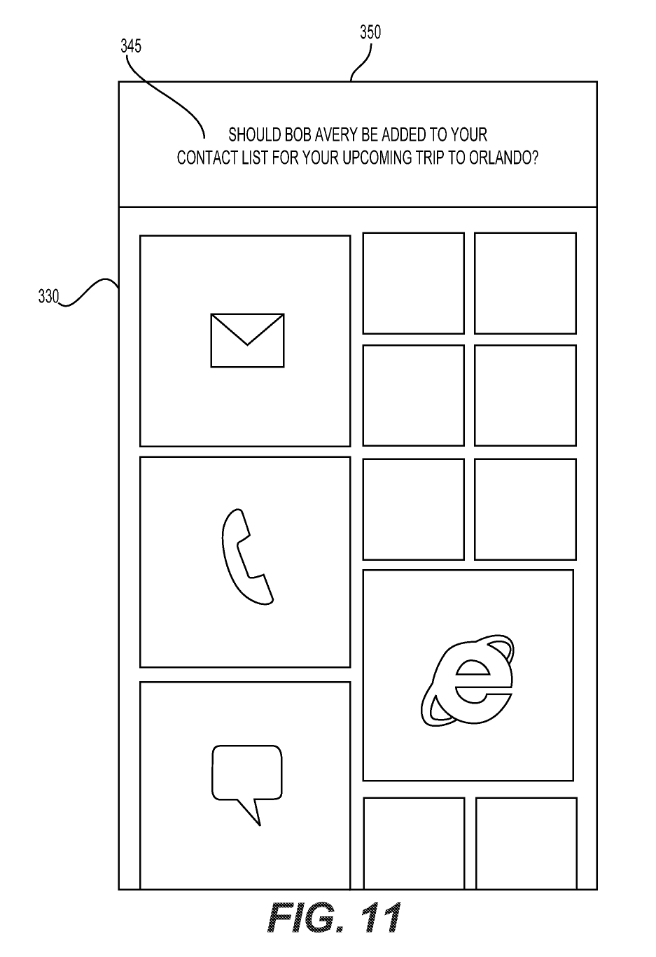

A user interface (UI) may be associated with the location-based address book component 450 which exposes various features, controls and options associated with the component. For instance, the UI may allow the user to control how the location-based address book is presented to the user. By way of example, the UI may allow the user to control what information is to be included in the various entries of the location-based address book (e.g. physical and electronic addresses mobile phone numbers company affiliation, addresses or other contact information for the user when visiting the specified geographic location, if available.) As another illustrative example, the UI may allow the user to control whether a notification is to be surfaced to the display of the device when the location-based address book component identifies a new contact that is going to be added to the location-based address book. FIG. 10 shows one example of a text string 340 that may be displayed by UI 350 on the device's start screen 330 when a contact is added in this manner. In some implementations such as shown in FIG. 11 the UI 350 may also present a text string 345 to allow the user to choose whether the newly identified contact should be added to the location-based address book.

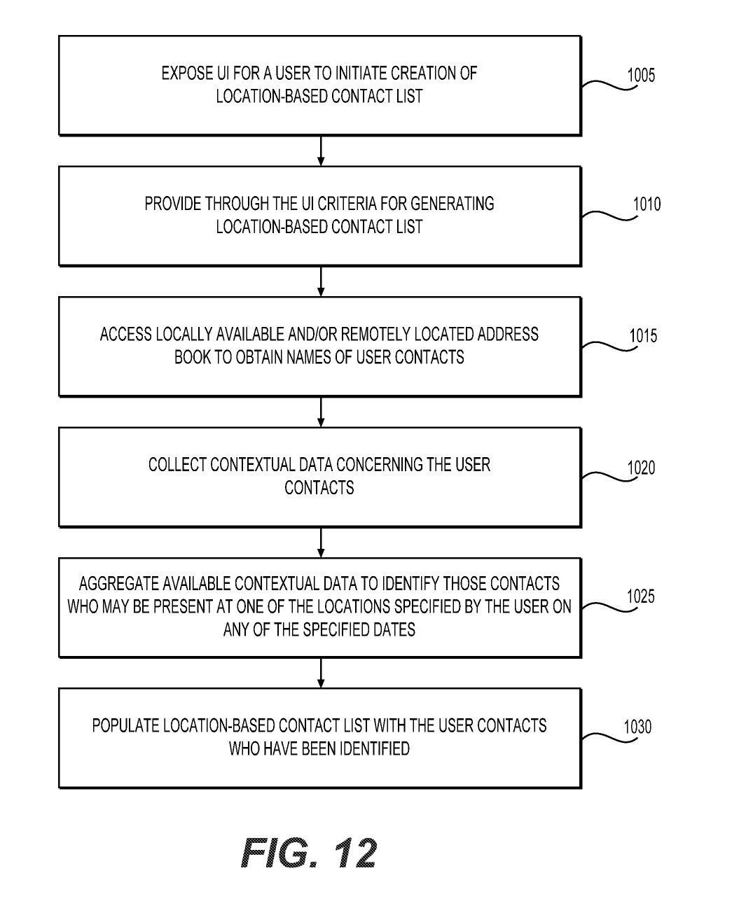

FIG. 12 shows a flowchart of an illustrative method 300 for generating a location-based address book or contact list. Unless specifically stated, the methods or steps shown in the flowchart below and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 1005, a UI can be exposed for a user to initiate the creation of location-based contact list. The UI may be incorporated into the UI exposed by a location-based address book component, although the process may be initiated by other components as well. The user uses the UI in step 1010 to provide the device with criteria to be used to generate a location-based contact list from among the user's various contacts. Among other things, the criteria may include the location(s) to which the user will be traveling and the date(s) on which the user will be visiting. In some implementations the user may specify whether the contacts to be searched are contacts stored in a local address book and/or a remotely located address book. Moreover, in some cases the user may also specify whether the contacts are to include contacts available through the user's social graph who the user has not directly entered into his or her address book. Other items that may be specified, for example, include whether any organizational contacts should be included who provide products and/or services at the specified location, and possibly what types of organizational contacts to include

In step 1015 the device can access the locally available and/or remotely located address book to obtain the names of the user's contacts. Next, in step 1020 the device collects contextual data concerning the user contacts. The contextual data may be obtained from internal sources such as locally stored applications, databases and the like. The contextual data also may be obtained from external sources such as external systems, databases and services. In step 1025 the device aggregates the various contextual data available to it and uses this data to identify those contacts (if any) who may be present at one of the locations specified by the user on any of the specified dates. In step 1030 the device then populates and stores a location-based contact list with the names of those user contacts who have been identified. In addition to the names of the contacts, the entries in the contact list may include additional information concerning the contacts.

Advantageously, the present location-based address book allows the user, and his or her device as well, to operate more efficiently. For example, the user does not need to search through large lists of contacts when attempting to find pertinent contacts while traveling. In addition, the use of a personal assistant component to identify contextually relevant information allows transmission bandwidth (and device power) to be efficiently utilized since only the information that is truly pertinent is provided to the user. Accordingly, the user does not need to employ a search engine to obtain information that may not be contextually relevant, which could consume excess bandwidth, time and power.

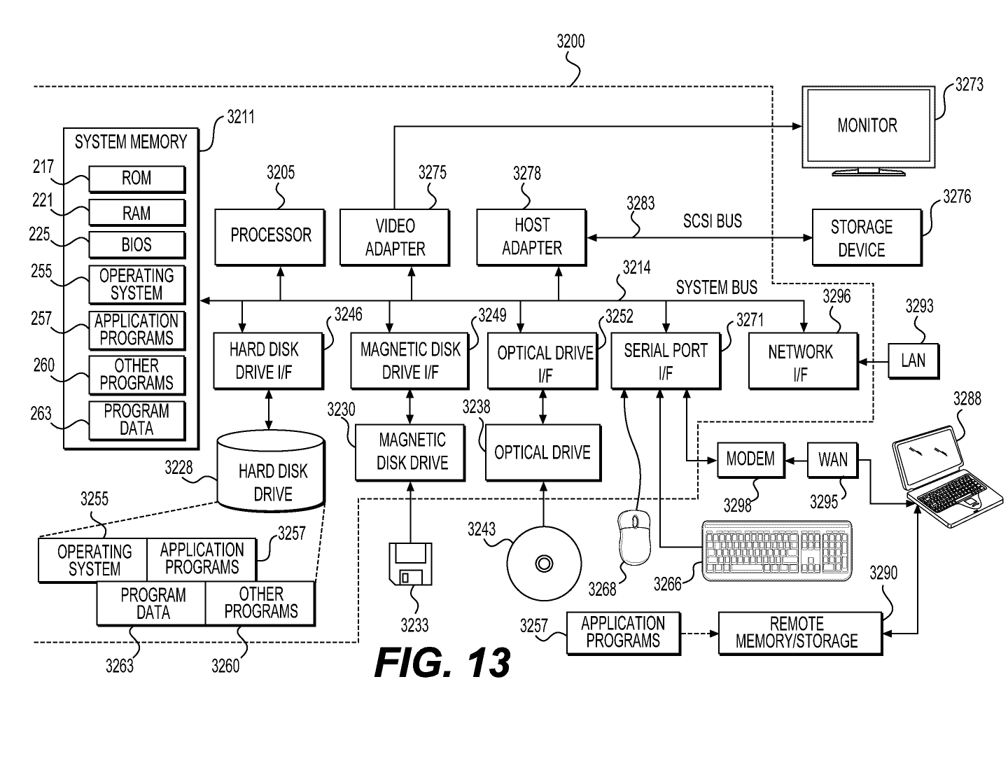

FIG. 13 is a simplified block diagram of an illustrative computer system 3200 such as a PC, client machine, or server with which the location-based address book component may be implemented. Computer system 3200 includes a processor 3205, a system memory 3211, and a system bus 3214 that couples various system components including the system memory 3211 to the processor 3205. The system bus 3214 may be any of several types of bus structures including a memory bus or memory controller, a peripheral bus, or a local bus using any of a variety of bus architectures. The system memory 3211 includes read only memory (ROM) 3217 and random access memory (RAM) 3221. A basic input/output system (BIOS) 3225, containing the basic routines that help to transfer information between elements within the computer system 3200, such as during startup, is stored in ROM 3217. The computer system 3200 may further include a hard disk drive 3228 for reading from and writing to an internally disposed hard disk (not shown), a magnetic disk drive 3230 for reading from or writing to a removable magnetic disk 3233 (e.g., a floppy disk), and an optical disk drive 3238 for reading from or writing to a removable optical disk 3243 such as a CD (compact disc), DVD (digital versatile disc), or other optical media. The hard disk drive 3228, magnetic disk drive 3230, and optical disk drive 3238 are connected to the system bus 3214 by a hard disk drive interface 3246, a magnetic disk drive interface 3249, and an optical drive interface 3252, respectively. The drives and their associated computer-readable storage media provide non-volatile storage of computer-readable instructions, data structures, program modules, and other data for the computer system 3200. Although this illustrative example includes a hard disk, a removable magnetic disk 3233, and a removable optical disk 3243, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present real-time sharing during a phone call. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 3233, optical disk 3243, ROM 3217, or RAM 3221, including an operating system 3255, one or more application programs 3257, other program modules 3260, and program data 3263. A user may enter commands and information into the computer system 3200 through input devices such as a keyboard 3266 and pointing device 3268 such as a mouse. Other input devices (not shown) may include a microphone, joystick, game pad, satellite dish, scanner, trackball, touchpad, touch screen, touch-sensitive device, voice-command module or device, user motion or user gesture capture device, or the like. These and other input devices are often connected to the processor 3205 through a serial port interface 3271 that is coupled to the system bus 3214, but may be connected by other interfaces, such as a parallel port, game port, or universal serial bus (USB). A monitor 3273 or other type of display device is also connected to the system bus 3214 via an interface, such as a video adapter 3275. In addition to the monitor 3273, personal computers typically include other peripheral output devices (not shown), such as speakers and printers. The illustrative example shown in FIG. 13 also includes a host adapter 3278, a Small Computer System Interface (SCSI) bus 3283, and an external storage device 3276 connected to the SCSI bus 3283.

The computer system 3200 is operable in a networked environment using logical connections to one or more remote computers, such as a remote computer 3288. The remote computer 3288 may be selected as another personal computer, a server, a router, a network PC, a peer device, or other common network node, and typically includes many or all of the elements described above relative to the computer system 3200, although only a single representative remote memory/storage device 3290 is shown in FIG. 13. The logical connections depicted in FIG. 13 include a local area network (LAN) 3293 and a wide area network (WAN) 3295. Such networking environments are often deployed, for example, in offices, enterprise-wide computer networks, intranets, and the Internet.

When used in a LAN networking environment, the computer system 3200 is connected to the local area network 3293 through a network interface or adapter 3296. When used in a WAN networking environment, the computer system 3200 typically includes a broadband modem 3298, network gateway, or other means for establishing communications over the wide area network 3295, such as the Internet. The broadband modem 3298, which may be internal or external, is connected to the system bus 3214 via a serial port interface 3271. In a networked environment, program modules related to the computer system 3200, or portions thereof, may be stored in the remote memory storage device 3290. It is noted that the network connections shown in FIG. 13 are illustrative and other means of establishing a communications link between the computers may be used depending on the specific requirements of an application of the present real-time sharing during a phone call.

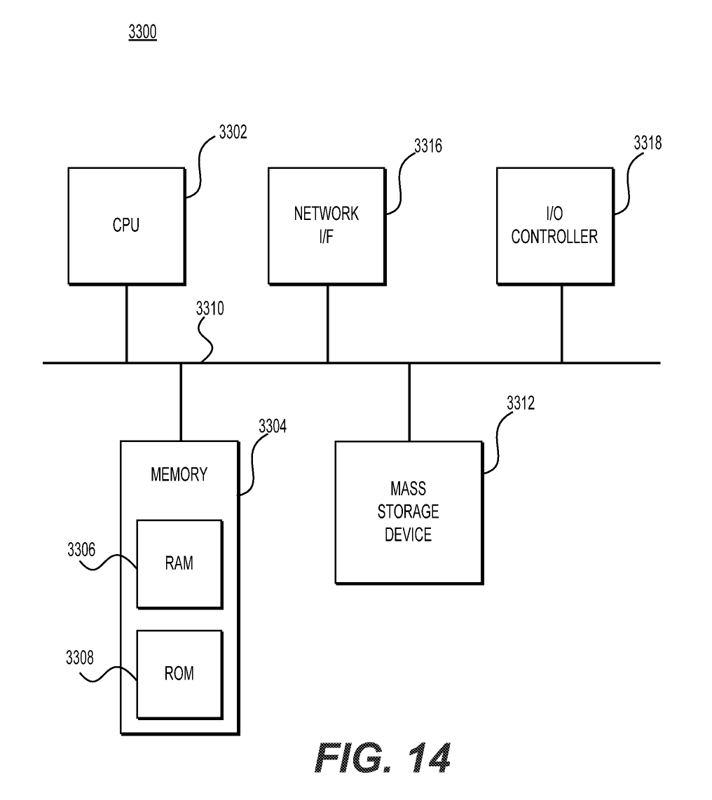

FIG. 14 shows an illustrative architecture 3300 for a device capable of executing the various components described herein for providing location-based contact lists. Thus, the architecture 3300 illustrated in FIG. 14 shows an architecture that may be adapted for a server computer, mobile phone, a PDA, a smartphone, a desktop computer, a netbook computer, a tablet computer, GPS device, gaming console, and/or a laptop computer. The architecture 3300 may be utilized to execute any aspect of the components presented herein.

The architecture 3300 illustrated in FIG. 14 includes a CPU (Central Processing Unit) 3302, a system memory 3304, including a RAM 3306 and a ROM 3308, and a system bus 3310 that couples the memory 3304 to the CPU 3302. A basic input/output system containing the basic routines that help to transfer information between elements within the architecture 3300, such as during startup, is stored in the ROM 3308. The architecture 3300 further includes a mass storage device 3312 for storing software code or other computer-executed code that is utilized to implement applications, the file system, and the operating system.

The mass storage device 3312 is connected to the CPU 3302 through a mass storage controller (not shown) connected to the bus 3310. The mass storage device 3312 and its associated computer-readable storage media provide non-volatile storage for the architecture 3300.

Although the description of computer-readable storage media contained herein refers to a mass storage device, such as a hard disk or CD-ROM drive, it may be appreciated by those skilled in the art that computer-readable storage media can be any available storage media that can be accessed by the architecture 3300.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 3300.

According to various embodiments, the architecture 3300 may operate in a networked environment using logical connections to remote computers through a network. The architecture 3300 may connect to the network through a network interface unit 3316 connected to the bus 3310. It may be appreciated that the network interface unit 3316 also may be utilized to connect to other types of networks and remote computer systems. The architecture 3300 also may include an input/output controller 3318 for receiving and processing input from a number of other devices, including a keyboard, mouse, or electronic stylus (not shown in FIG. 14). Similarly, the input/output controller 3318 may provide output to a display screen, a printer, or other type of output device (also not shown in FIG. 14).

It may be appreciated that the software components described herein may, when loaded into the CPU 3302 and executed, transform the CPU 3302 and the overall architecture 3300 from a general-purpose computing system into a special-purpose computing system customized to facilitate the functionality presented herein. The CPU 3302 may be constructed from any number of transistors or other discrete circuit elements, which may individually or collectively assume any number of states. More specifically, the CPU 3302 may operate as a finite-state machine, in response to executable instructions contained within the software modules disclosed herein. These computer-executable instructions may transform the CPU 3302 by specifying how the CPU 3302 transitions between states, thereby transforming the transistors or other discrete hardware elements constituting the CPU 3302.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 3300 in order to store and execute the software components presented herein. It may also be appreciated that the architecture 3300 may include other types of computing devices, including handheld computers, embedded computer systems, smartphones, PDAs, and other types of computing devices known to those skilled in the art. It is also contemplated that the architecture 3300 may not include all of the components shown in FIG. 14, may include other components that are not explicitly shown in FIG. 14, or may utilize an architecture completely different from that shown in FIG. 14.

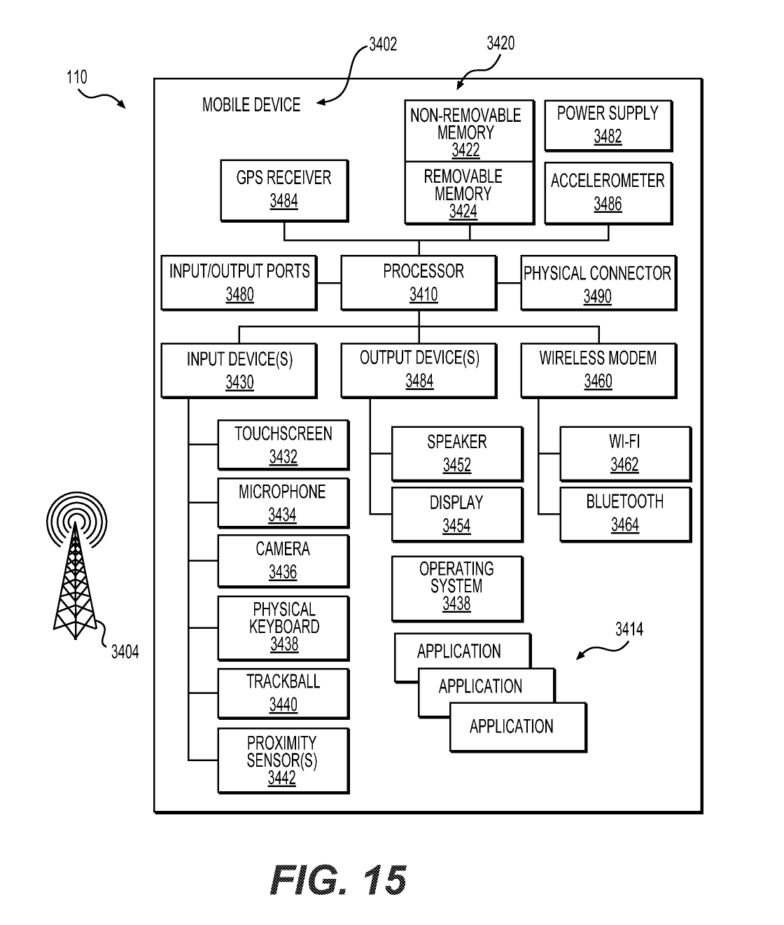

FIG. 15 is a functional block diagram of an illustrative mobiledevice 110 such as a mobile phone or smartphone including a variety of optional hardware and software components, shown generally at 3402. Any component 3402 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 3404, such as a cellular or satellite network.

The illustrated device 110 can include a controller or processor 3410 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 3412 can control the allocation and usage of the components 3402, including power states, above-lock states, and below-lock states, and provides support for one or more application programs 3414. The application programs can include common mobile computing applications (e.g., image-capture applications, email applications, calendars, contact managers, web browsers, messaging applications), or any other computing application.

The illustrated mobile device 110 can include memory 3420. Memory 3420 can include non-removable memory 3422 and/or removable memory 3424. The non-removable memory 3422 can include RAM, ROM, Flash memory, a hard disk, or other well-known memory storage technologies. The removable memory 3424 can include Flash memory or a Subscriber Identity Module (SIM) card, which is well known in GSM (Global System for Mobile communications) systems, or other well-known memory storage technologies, such as “smart cards.” The memory 3420 can be used for storing data and/or code for running the operating system 3412 and the application programs 3414. Example data can include web pages, text, images, sound files, video data, or other data sets to be sent to and/or received from one or more network servers or other devices via one or more wired or wireless networks.

The memory 3420 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the mobile device 110.

The memory 3420 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The mobile device 110 can support one or more input devices 3430; such as a touch screen 3432; microphone 3434 for implementation of voice input for voice recognition, voice commands and the like; camera 3436; physical keyboard 3438; trackball 3440; and/or proximity sensor 3442; and one or more output devices 3450, such as a speaker 3452 and one or more displays 3454. Other input devices (not shown) using gesture recognition may also be utilized in some cases. Other possible output devices (not shown) can include piezoelectric or haptic output devices. Some devices can serve more than one input/output function. For example, touchscreen 3432 and display 3454 can be combined into a single input/output device.

A wireless modem 3460 can be coupled to an antenna (not shown) and can support two-way communications between the processor 3410 and external devices, as is well understood in the art. The modem 3460 is shown generically and can include a cellular modem for communicating with the mobile communication network 3404 and/or other radio-based modems (e.g., Bluetooth 3464 or Wi-Fi 3462). The wireless modem 3460 is typically configured for communication with one or more cellular networks, such as a GSM network for data and voice communications within a single cellular network, between cellular networks, or between the mobile device and a public switched telephone network (PSTN).

The mobile device can further include at least one input/output port 3480, a power supply 3482, a satellite navigation system receiver 3484, such as a GPS receiver, an accelerometer 3486, a gyroscope (not shown), and/or a physical connector 3490, which can be a USB port, IEEE 1394 (FireWire) port, and/or an RS-232 port. The illustrated components 3402 are not required or all-inclusive, as any components can be deleted and other components can be added.

Based on the foregoing, it may be appreciated that technologies for generating location-based contact lists and address books have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and may not be construed as limiting. Various modifications and changes may be made to the subject matter described herein without following the example embodiments and applications illustrated and described, and without departing from the true spirit and scope of the present invention, which is set forth in the following claims.

What is claimed:

1. One or more computer-readable memories storing instructions which, when executed by one or more processors disposed in a device, implement a method for dynamically generating a location-based contact list available on a local device of a user, comprising:
identifying a subset of user contacts selected from a contact list of the user based on a specified geographic location, the user contacts in the subset being user contacts who will be present at the specified geographic location at a first future time; and
storing the subset of user contacts so that it is accessible for display on the local device.

2. The one or more computer readable memories of claim 1 further including identifying the subset of user contacts based on receipt of user input specifying that the user will be present at the geographic location at a second future time that overlaps with the first future time.

3. The one or more computer-readable memories of claim 1 further including identifying the subset of user contacts from information obtained from one or more social networking services.

4. The one or more computer-readable memories of claim 1 further including identifying the subset of user contacts from contextual data obtained from on-line behavior of the contacts in the context list.

5. The one or more computer-readable memories of claim 1 further including identifying the subset of user contacts from one or more calendars associated with the contacts in the contact list.

6. The one or more computer-readable memories of claim 1 further including exposing a control for selecting which of the user contacts in the subset are to be stored in a location-based address book tailored for the specified geographic location.

7. The one or more computer-readable memories of claim 1 further including identifying one or more organizational contacts that provide services at the specified geographic location and storing the one or more organization contacts in a location-based address book tailored for the specified geographic location, the location-based address book further including the subset of user contacts who have been identified.

8. The one or more computer-readable memories of claim 1 further including providing a notification when a user contact is identified as belonging to the subset of user contacts.

9. A system, comprising:
one or more processors;
a display that supports a user interface (UI) for interacting with a device user; and
a memory storing computer-readable instructions which, when executed by the one or more processors, perform a method for dynamically generating a location-based contact list, the method comprising:
collecting contextual data concerning user contacts, the contextual data describing behavior of the user contacts that provides an indicia of geographic locations where the user contacts will be present at future times;
based on the collected contextual data, identifying selected ones of the user contacts who will be present at a specified geographic location at a specified future time; and
populating a location-based contact list with the selected ones of the user contacts who will be present at the specified geographic location at the specified future time.

10. The system of claim 9 further comprising enabling interaction with the UI using one of natural language, voice command, gesture, or physical contact using a touchscreen or manipulation of a physical or a virtual control.

11. The system of claim 9 further comprising interacting with a digital assistant to invoke or control one or more of the method steps.

12. The system of claim 11 further comprising utilizing the digital assistant to provide a notification before an identified user contact is added to the location-based contact list.

13. The system of claim 11 further comprising utilizing the digital assistant to specify one or more criteria to be employed when generating the location-based contact list.

14. The system of claim 11 in which the UI is invoked from a UI exposed by an address book application.

15. A method for generating a location-based contact list, comprising:
receiving from a user a request to identify user contacts who will be at a geographic location at a specified future time when the user will also be present at the geographic location;
accessing a list of contacts associated with the user;
searching the list of user contacts to identify a subset thereof who will be present at the geographic location during at least a portion of the specified future time; and
storing the subset of user contacts so that it is accessible to the user separately from remaining ones of the user contacts.

16. The method of claim 17 in which searching the list of user contacts further includes:
collecting contextual data concerning the user contacts, the contextual data describing behavior of the user contacts that provides an indicia of geographic locations where the user contacts will be present at future times; and
identifying the subset of user contacts based on the collected contextual data.

17. The method of claim 17 in which accessing and searching the list of user contacts further includes searching a social graph associated with the user.

18. The method of claim 17 further including exposing a control for selecting which of the user contacts in the subset are to be stored in a location-based address book tailored for the geographic location.

19. The method of claim 17 further including identifying one or more organizational contacts that provide products and/or services at the geographic location and storing the one or more organization contacts in a location-based address book tailored for the specified geographic location, the location-based address book further including the subset of user contacts who have been identified.

20. The method of claim 17 further including facilitating the collection of the contextual data by utilizing a personal digital assistant.
